(19) United States
(12) Patent Application Publication
(10) Pub. No.: US 2026/0161062 A1
(43) Pub. Date: Jun. 11, 2026

(54) PROJECTION LIGHT SOURCE AND PROJECTION DEVICE

(71) Applicant: HISENSE LASER DISPLAY CO., LTD., Qingdao (CN)

(72) Inventors: Wei LI, Qingdao (CN); Xiaoqiang GU, Qingdao (CN); Youliang TIAN, Qingdao (CN)

(21) Appl. No.: 19/179,722

(22) Filed: Apr. 15, 2025

Related U.S. Application Data
(63) Continuation of application No. PCT/CN2023/103396, filed on Jun. 28, 2023.

(30) Foreign Application Priority Data
Oct. 28, 2022 (CN) 202211338514.9

(51) Int. Cl. G03B 21/14; G03B 21/20; G03B 33/12

(52) U.S. Cl. CPC G03B 21/147; G03B 21/204; G03B 21/2066; G03B 21/208; G03B 33/12

(57) ABSTRACT

The present disclosure discloses a projection light source. In the projection light source, the first etendue adjustment component and the second etendue adjustment component are both moving components; the laser device is configured to emit laser light of at least one color, the first optical path guiding element is configured to guide the laser light of at least one color to the first etendue adjustment component, and the first etendue adjustment component is configured to increase a first etendue of incident laser light and then emit the laser light that has increased the first etendue; and the second etendue adjustment component is configured to increase a second etendue of incident laser light and then emit the laser light that has increased the second etendue.

This application is a continuation application of PCT application No. PCT/CN 2023/103396, filed on Jun. 28, 2023, which claims priority to Chinese Patent Application No. 202211338514.9, filed on Oct. 28, 2022, and entitled “PROJECTION LIGHT SOURCE AND PROJECTION DEVICE”, the disclosures of which are herein incorporated by reference in their entireties.

### TECHNICAL FIELD

The present disclosure relates to the field of optoelectronics technologies, and in particular, relates to a projection light source and a projection device.

### BACKGROUND

With the development of optoelectronic technology, projection devices are widely used.

In the related art, a laser device is used in a projection light source of a projection device to emit laser light of various colors, and a projection image can be formed and projected based on the laser light. The laser device emits laser light of various colors with high coherence, and bright and dark spots will appear in the projection image formed by the laser light, and the phenomenon of such spots appearing in the projection image is called a speckle phenomenon. The speckles will reduce the user's visual experience of the projected image.

### SUMMARY

In one aspect of the present disclosure, a projection light source is provided. The projection light source includes a laser device, a first optical path guiding element, a second optical path guiding element, a first etendue adjustment component, and a second etendue adjustment component, wherein the first etendue adjustment component and the second etendue adjustment component are both moving components; wherein

the laser device is configured to emit laser light of at least one color, the first optical path guiding element is configured to guide the laser light of at least one color to the first etendue adjustment component, and the first etendue adjustment component is configured to increase a first etendue of incident laser light and then emit the laser light that has increased the first etendue; and

the number of second optical path guiding elements and the number of second etendue adjustment components are both greater than or equal to one, wherein each of the second optical path guiding elements corresponds to one second etendue adjustment component; each of the second optical path guiding elements is configured to receive laser light emitted from one etendue adjustment component other than the corresponding second etendue adjustment component, and guide the received laser light to be incident on the corresponding the second etendue adjustment component, and each of the second etendue adjustment components is configured to increase a second etendue of incident laser light and then emit the laser light that has increased the second etendue.

In another aspect of the present disclosure, a projection device is provided. The projection device comprises a projection light source as described above, a light valve, and a lens; wherein

the projection light source is configured to emit laser light to the light valve, the light valve is configured to modulate the received laser light and then emit the modulated laser light to the lens, and the lens is configured to project the received laser light to form a projection image.

### BRIEF DESCRIPTION OF DRAWINGS

For clearer descriptions of the technical solutions in the embodiments of the present disclosure, the following briefly introduces the accompanying drawings required for describing the embodiments. The accompanying drawings in the following descriptions show merely some embodiments of the present disclosure, and persons of ordinary skill in the art may still derive other drawings from these accompanying drawings without creative effort.

FIG. 1 is a schematic structural diagram of a projection light source according to some embodiments of the present disclosure;

FIG. 2 is a schematic structural diagram of another projection light source according to some embodiments of the present disclosure;

FIG. 3 is a schematic structural diagram of still another projection light source according to some embodiments of the present disclosure;

FIG. 4 is a schematic structural diagram of a diffuser wheel according to some embodiments of the present disclosure;

FIG. 5 is a schematic structural diagram of yet another projection light source according to some embodiments of the present disclosure;

FIG. 6 is a schematic structural diagram of another diffuser wheel according to some embodiments of the present disclosure;

FIG. 7 is a schematic structural diagram of a projection light source according to other embodiments of the present disclosure;

FIG. 8 is a schematic structural diagram of still another diffuser wheel according to some embodiments of the present disclosure;

FIG. 9 Schematic structural diagram of another projection light source according to other embodiments of the present disclosure;

FIG. 10 is a schematic structural diagram of yet another diffuser wheel according to some embodiments of the present disclosure;

FIG. 11 is a schematic structural diagram of still another projection light source according to other embodiments of the present disclosure;

FIG. 12 is a schematic structural diagram of a diffuser wheel according to other embodiments of the present disclosure;

FIG. 13 is a schematic structural diagram of yet another projection light source according to other embodiments of the present disclosure;

FIG. 14 is a schematic structural diagram of another diffuser wheel according to other embodiments of the present disclosure;

FIG. 15 is a schematic structural diagram of a projection light source according to still other embodiments of the present disclosure;

FIG. 16 is a schematic structural diagram of another projection light source according to still other embodiments of the present disclosure;

FIG. 17 is a schematic structural diagram of yet another projection light source according to still other embodiments of the present disclosure;

FIG. 18 is a schematic structural diagram of yet another projection light source according to still other embodiments of the present disclosure;

FIG. 19 is a schematic structural diagram of a projection light source according to yet other embodiments of the present disclosure;

FIG. 20 is a schematic structural diagram of another projection light source according to yet other embodiments of the present disclosure;

FIG. 21 is a schematic structural diagram of a laser device according to some embodiments of the present disclosure;

FIG. 22 is a schematic structural diagram of another laser device according to some embodiments of the present disclosure;

FIG. 23 is a schematic structural diagram of still another laser device according to some embodiments of the present disclosure;

FIG. 24 is a schematic structural diagram of yet another laser device according to some embodiments of the present disclosure;

FIG. 25 is a schematic diagram of a light spot formed by laser light emitted from a laser device according to some embodiments of the present disclosure;

FIG. 26 is a partial schematic structural diagram of a projection light source according to some embodiments of the present disclosure;

FIG. 27 is a schematic structural diagram of a portion of another projection light source according to some embodiments of the present disclosure;

FIG. 28 is a schematic structural diagram of a portion of still another projection light source according to some embodiments of the present disclosure;

FIG. 29 is a schematic structural diagram of a portion of yet another projection light source according to some embodiments of the present disclosure;

FIG. 30 is a schematic diagram of a light spot formed by a laser light directed to a light-combining component according to some embodiments of the present disclosure;

FIG. 31 is a schematic diagram of a light spot formed by a laser light emitted from a light-combining component according to some embodiments of the present disclosure;

FIG. 32 is a schematic structural diagram of yet another projection light source according to yet other embodiments of the present disclosure; and

FIG. 33 is a schematic structural diagram of a projection device according to some embodiments of the present disclosure.

### DETAILED DESCRIPTION

To make the purposes, technical solutions, and advantages of the present disclosure clearer, the embodiments of the present disclosure will be described in further detail below in conjunction with the accompanying drawings.

With the development of optoelectronic technology, projection devices are being applied more and more widely, and the requirements for the display effect of the projection images of projection devices are getting higher and higher. Due to the high coherence of the laser light, the speckle phenomenon will occur in the formed projection image, which affects the display effect of the projection image. Therefore, how to better eliminate the speckles has become the research focus of the laser projection industry. The following embodiments of this application provide a projection light source and a projection device, which can play a good role in weakening the speckle phenomenon of the projection image. The laser light emitted based on this projection light source can form a projection image with a better display effect.

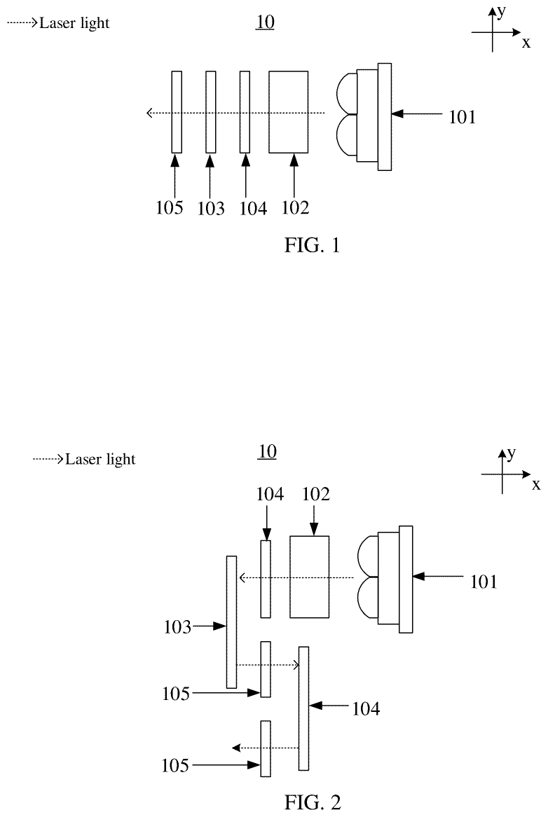

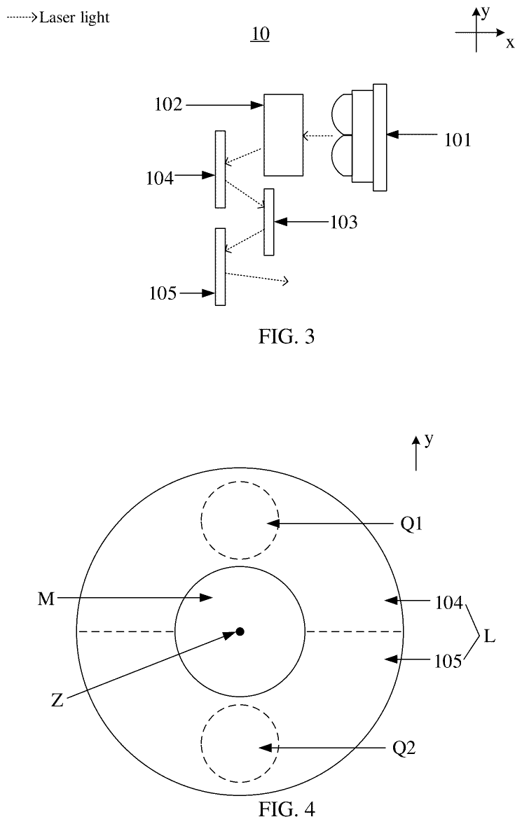

FIG. 1 is a schematic structural diagram of a projection light source according to some embodiments of the present disclosure, FIG. 2 is a schematic structural diagram of another projection light source according to some embodiments of the present disclosure, and FIG. 3 is a schematic structural diagram of still another projection light source according to some embodiments of the present disclosure. As shown in FIGS. 1 to 3, the projection light source 10 includes a laser device 101, a first optical path guiding element 102, a second optical path guiding element 103, a first etendue adjustment component 104, and a second etendue adjustment component 105.

The laser device 101 is used to emit laser light of at least one color. The laser device 101 in the embodiment of the present disclosure may be a monochromatic laser device or a multicolor laser device. The monochromatic laser device is only used to emit laser light of one color, and the multicolor laser device can emit laser light of multiple colors. The first optical path guiding element 102 is used to guide the laser light of at least one color emitted from the laser device 101 to be incident on the first etendue adjustment component 104, and the first etendue adjustment component 104 is used to increase the first etendue of the incident laser light and then emit the laser light.

The number of the second optical path guiding elements 103 and the number of the second etendue adjustment components 105 are both greater than or equal to one, and each of the second optical path guiding elements 103 corresponds to one of the second etendue adjustment components 105. The number of the second optical path guiding elements 103 and the number of the second etendue adjustment components 105 may be equal, and the second optical path guiding elements 103 are in one-to-one correspondence with the second etendue adjustment components 105. In a specific embodiment, the number of second optical path guiding elements 103 may also be greater than the number of second etendue adjustment components 105, and there may be two or more second optical path guiding elements 103 corresponding to the same second etendue adjustment component 105.

The second optical path guiding element 103 is used to receive laser light emitted from an etendue adjustment component other than the corresponding second etendue adjustment component 105, and guide the received laser light to be incident on the corresponding second etendue adjustment component 105. The second etendue adjustment component 105 is used to increase the second etendue of the incident laser light and then emit it. For one second optical path guiding element 103, the etendue adjustment component other than the second etendue adjustment component 105 corresponding to the second optical path guiding element 103 may be a first etendue adjustment component 104 or another second etendue adjustment component 105. In a specific embodiment, the first etendue adjustment component 104 may also serve as the second etendue adjustment component corresponding to a certain second optical path guiding element 103. In this way, the laser light emitted from the laser device 101 in the projection light source 10 can be increased by the amount of etendue multiple times, which may be equal to the number of the second optical path guiding elements 103 plus one.

It should be noted that the etendue is the integral of the light beam source area and the solid angle occupied by the light beam. The etendue can measure the changes in the light beam source area and the solid angle of the light beam when the light beam passes through an optical system. The larger the light beam source area or the solid angle, the larger the etendue. Increasing the etendue of the light beam can be achieved by increasing at least one of the light beam source area and the solid angle. The light beam source area can also be regarded as the area of the light spot formed by the light beam, and the solid angle can be regarded as the divergence angle of the light beam. In the embodiment of the present disclosure, the first etendue adjustment component 104 and the second etendue adjustment component 105 can increase the etendue of the received laser light, and can diffuse the laser light to increase the area of the laser spot or the divergence angle of the laser light.

The degree of diffusion of the received laser light by each etendue adjustment component in the projection light source 10 may be the same or different, and the embodiments of the present disclosure do not limit the etendue increased by each etendue adjustment component to the laser light. Exemplarily, the first etendue adjustment component 104 increases a first etendue of the received laser light, and the second etendue adjustment component 105 increases a second etendue of the received laser light, and the first etendue may be equal to the second etendue or greater or less than the second etendue. The second etendue corresponding to each second etendue adjustment component 105 may be the same or different.

In the projection light source 10 provided by the embodiments of the present disclosure, as shown in FIGS. 1 and 2, the projection light source 10 may include one first etendue adjustment component 104 and one second etendue adjustment component 105. The laser light emitted from the laser device 101 is guided by the first optical path guiding element 102 to be incident on the first etendue adjustment component 104. The laser light emitted from the first etendue adjustment component 103 may be directed to one second optical path guiding element 103, so as to be guided and to be incident on the corresponding second etendue adjustment component 105 and emitted. Since both the first etendue adjustment component 104 and the second etendue adjustment component 105 are used to increase the etendue of the laser light, the laser light emitted from the laser device 101 in the embodiment of the present disclosure can undergo two increases in etendue which has a strong effect on the reduction of the coherence of the laser light, and can reduce the speckle effect of the projection image formed based on the laser light.

As shown in FIG. 3, the projection light source 10 may include an etendue adjustment component 104 and a plurality of second etendue adjustment components 105, and FIG. 3 shows two second etendue adjustment components 105 as an example. The laser light emitted from the first etendue adjustment component 103 may be directed to one second optical path guiding element 103 to be guided and incident on the corresponding second etendue adjustment component 105 and emitted. The laser light emitted from the second etendue adjustment component 105 may be directed to another second optical path guiding element 103 to be guided to the corresponding second etendue adjustment component 105 and emitted. In this way, the laser light emitted from the laser device 101 can undergo three increases in etendue, which further reduces the coherence of the laser light.

In this embodiment of the present disclosure, as shown in FIG. 1, the first etendue adjustment component 104, the second optical path guiding element 103, and the second etendue adjustment component 105 in the projection light source 10 may be arranged in the same straight line; or, as shown in FIGS. 2 and 3, the first etendue adjustment component 104 and the second etendue adjustment component 105 may be arranged in the same plane, and the second optical path guiding element 103 is used to change the transmission direction of the laser light; or, the etendue adjustment components and the optical path guiding elements may also be arranged in any other arrangement mode, and the arrangement positions of the etendue adjustment components and the optical path guiding elements are not limited in the embodiments of the present disclosure.

In the embodiments of the present disclosure, the first etendue adjustment component 104 and the second etendue adjustment component 105 may both be moving components. Each of the etendue adjustment components can rotate, translate, or move in other ways, which is not limited in the embodiments of the present disclosure. For one etendue adjustment component, when the etendue adjustment component moves, the laser light can be directed towards different positions of the etendue adjustment component at different moments, which is equivalent to the laser light being adjusted by different etendue adjustment components at different moments. In this way, the coherence of the laser light in the time dimension can be weakened, and the effect on reducing the speckles of the projection image formed based on the laser light is better.

In summary, in the projection light source provided by the embodiments of the present disclosure, laser light emitted from a laser device can be guided by a first optical path guiding element to a first etendue adjustment component, so as to cause the laser light to increase a first etendue under the action of the first etendue adjustment component. A second optical path guiding element can guide laser light emitted from other etendue adjustment components (e.g., the first etendue adjustment component or other second etendue adjustment components) to a corresponding second etendue adjustment component, so as to cause the laser light to increase a second etendue under the action of the second etendue adjustment component. In this way, the laser light emitted from the laser device can undergo at least two increases in etendue, such that the coherence of the laser light can be largely eliminated, the speckle phenomenon of the projection image formed based on the laser light can be weakened, and the display effect of the projection image can be improved.

Moreover, both the first etendue adjustment component and the second etendue adjustment component are moving components. In this way, the laser light directed to the same etendue adjustment component at different moments can be directed to different positions of the etendue adjustment component, which can weaken the coherence of the laser light in the time dimension and has a better effect on reducing speckles of the projection image formed based on the laser light.

In a specific embodiment, any of the etendue adjustment components in the projection light source 10 may be a transmissive diffuser or a reflective diffuser. In a transmissive diffuser, the light-incident surface and the light-output surface of the laser light are two opposite surfaces. In a reflective diffuser, the light-incident surface and the light-output surface of the laser light are the same surface, and a surface opposite to the light-incident surface is the reflective surface. FIGS. 1 and 2 take the case where both the first etendue adjustment component 104 and the second etendue adjustment component 105 in the projection light source 10 are transmissive diffusers as an example. FIG. 3 takes the case where the projection light source 10 includes one first etendue adjustment component 104 and one second etendue adjustment component 105, and the first etendue adjustment component 104 and the second etendue adjustment component 105 are both reflective diffusers as an example. The diffusion of the laser light by the diffuser means expanding the divergence angle of the laser light. As a result, the laser light entering the diffuser at different positions can mix after exiting the diffuser, and the originally spatially adjacent laser light can increase the distance between each other after exiting the diffuser. In this way, the spatial coherence of the laser light can be reduced, thereby achieving the effect of speckle reduction. The diffusion of the laser light by the diffuser can also correspondingly enhance the homogenization effect of the laser light.

Each of the etendue adjustment components in the projection light source 10 can be rotated around the same rotational shaft. In a plane perpendicular to the rotational shaft, an orthographic projection of at least a portion of each of the etendue adjustment components is outside an orthographic projection of other etendue adjustment components, i.e. at least a portion of the different etendue adjustment components do not overlap. The laser light directed to each etendue adjustment component may be directed into a region of the etendue adjustment component that does not overlap with the other etendue adjustment components. The rotational shaft described in embodiments of the present disclosure may refer to a solid structure or a straight line and not a solid structure. Each etendue adjustment component may be located in the same plane, such as the plane perpendicular to the rotational shaft, and the etendue adjustment components all rotate around the same point in the rotational shaft; alternatively, each etendue adjustment component may be located in different planes, such as the etendue adjustment components are all perpendicular to the rotational shaft and different etendue adjustment component rotates around different points in the rotational shaft, or the etendue adjustment components may not be perpendicular to the rotational shaft. Each of the etendue adjustment components may be substantially plate-shaped, and the etendue adjustment components may have two larger surfaces opposite each other and a plurality of smaller side surfaces connected to the two surfaces. The two larger surfaces are the plate surfaces of the etendue adjustment component. The description of the etendue adjustment component being located in a certain plane in the embodiments of the present disclosure refers to the plate surface of the etendue adjustment component being located in the plane, and whether the etendue adjustment component is perpendicular to the rotational shaft refers to whether the plate surface of the etendue adjustment component is perpendicular to the rotational shaft.

In an optional implementation, the etendue adjustment components may be arranged around the rotational shaft in a layout similar to the arrangement of fan blades, and each etendue adjustment component is not perpendicular to the rotational shaft. In a plane perpendicular to the rotational shaft, the orthographic projections of the adjacent etendue adjustment components may overlap or not overlap. In a specific embodiment, the etendue adjustment components may be in a flat shape or may have some curvature. The laser light can be directed to the etendue adjustment component in a direction parallel to the rotational shaft. Since the etendue adjustment component is arranged obliquely relative to the rotational shaft, the optical path of the laser light in the etendue adjustment component can be relatively long, which can result in a better diffusion effect on the laser light.

In another optional implementation, the projection light source 10 may include a diffuser wheel, the above-mentioned rotational shaft may be a rotational shaft of the diffuser wheel, and the various etendue adjustment components may be different regions (which may also be referred to as diffusion regions) in the diffuser wheel, respectively. FIG. 4 is a schematic structural diagram of a diffuser wheel according to some embodiments of the present disclosure. As shown in FIG. 4, the diffuser wheel is in the shape of a wheel, and the diffuser wheel may include a wheel piece L, and a motor M fixed to the wheel piece L and located at a central position of the wheel piece L. The wheel piece L may be rotated around a rotational shaft Z driven by the motor M. The various regions in the wheel piece of the diffuser wheel can diffuse the received laser light. The regions in the diffuser wheel described in the embodiments of the present disclosure all refer to regions in the wheel piece L of the diffuser wheel.

In a specific embodiment, the wheel piece L of the diffuser wheel may have a plurality of diffuser microstructures (e.g., strip-like projections or other shaped microstructures), and the diffuser microstructures are distributed at various positions of the wheel piece L, and the diffuser wheel utilizes the diffuser microstructures to diffuse the received laser light. The diffuser microstructures in different regions of the diffuser wheel can be different, such that with the rotation of the diffuser wheel, the laser light can be directed to different positions of the diffuser wheel. The diffuser wheel can diffuse laser light differently, such that the laser light emitted after the diffuser wheel can have different phases. The diffuser wheel diffuses the laser light during the rotation process, which can ensure that the laser light directed to the same position in space at different times passes through different positions of the diffuser wheel, causing a phase difference in the laser light emitted from the same position at different times. In this way, the light spot formed by the laser light emitted from the same position within a unit of time can be the superposition of multiple different speckle patterns. Therefore, the speckle phenomenon can be weakened, achieving the effect of speckle reduction.

In a specific embodiment, the wheel piece L may include only a diffuser sheet, or the wheel piece L may also include a carrier sheet and a diffuser sheet located on the carrier sheet. The diffuser sheet is used to diffuse the laser light, and the carrier sheet is transparent to light. In a specific embodiment, the diffuser microstructure in the wheel piece L of the diffuser wheel may be a structure in the diffuser sheet. The embodiments of the present disclosure are illustrated by taking the case where the diffuser wheel includes a transmissive diffuser sheet as an example. The diffuser wheel may also include a reflective diffuser sheet.

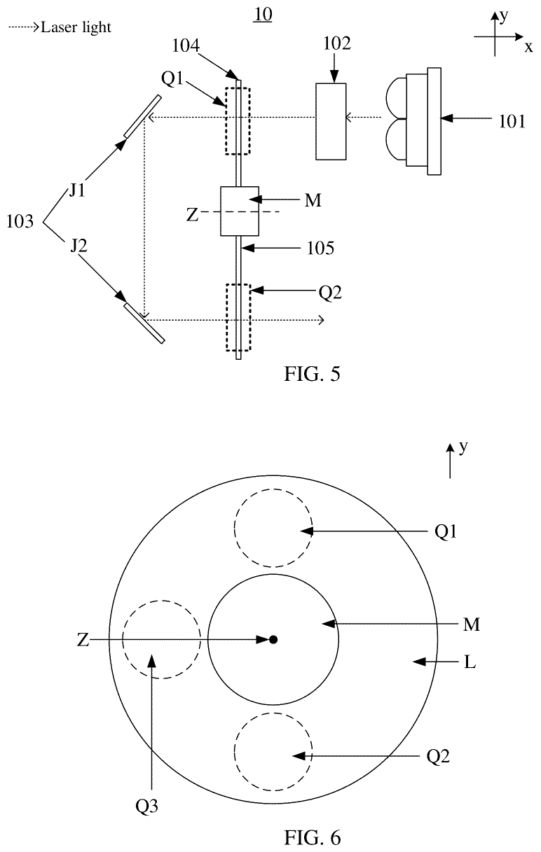

The wheel piece L may be in a ring or a circular shape. For example, the wheel piece L is in a ring shape, and different etendue adjustment components in the projection light source 10 may be different sector-ring regions in the circumferential direction of the wheel piece L, respectively. For another example, the wheel piece L is in a circular shape, and the different etendue adjustment components may be different sectoral regions in the circumferential direction of the wheel piece L, respectively. As shown in FIG. 4, the wheel piece L of the diffuser wheel is in a circular shape, the first etendue adjustment component 104 and the second etendue adjustment component 105 are both in a semi-circular shape, and the first etendue adjustment component 104 and the second etendue adjustment component 105 form the wheel piece L of the diffuser wheel. FIG. 5 is a schematic structural diagram of yet another projection light source according to some embodiments of the present disclosure, the projection light source shown in FIG. 5 includes a diffuser wheel as shown in FIG. 4, and FIG. 4 may be a left view or a right view of the diffuser wheel in the projection light source shown in FIG. 5. Combined with FIG. 4 and FIG. 5, the first optical path guiding element 102 may guide the laser light to the first region Q1 in the first etendue adjustment component 104, and the laser light emitted from the first etendue adjustment component 104 is guided by the second optical path guiding element 103 to pass through the second region Q2 in the second etendue adjustment component 105. The first region Q1 and the second region Q2 may be located on opposite sides of the rotational shaft Z, and the rotational shaft Z may be located between the first region Q1 and the second region Q2, e.g., the rotational shaft Z passes through a line connecting the center of the first region Q1 and the center of the second region Q2. In a specific embodiment, the first region Q1 and the second region Q2 may not be located on opposite sides of the rotational shaft Z, e.g., the second region Q2 is located on the left side or right side in FIG. 4, which is only necessary to ensure that the first region Q1 is different from the second region Q2.

It should be noted that the relative positional relationship between the diffuser wheel and the other components in the projection light source 10 remains unchanged, and the transmission path of the laser light in the projection light source 10 remains unchanged, but because the piece blade of the diffuser wheel rotates around the rotational shaft, different positions in the diffuser wheel receive laser light at different moments as the diffuser wheel rotates. In the case that each etendue adjustment component is a different diffusion region in the diffuser wheel and is located in the same annular region of the diffuser wheel, each etendue adjustment component refers to a region of the diffuser wheel that is irradiated by the laser light guided by the corresponding optical path guiding element, rather than a certain fixed region in the diffuser wheel. For example, the first etendue adjustment component 104 at different moments is actually different regions of the diffuser wheel at a fixed spatial position.

FIGS. 4 and 5 take the case as an example where the laser light in the projection light source 10 passes through the diffuser wheel twice, and the diffuser wheel includes only one first etendue adjustment component 104 and one second etendue adjustment component 105. In a specific implementation, there may be a plurality of second etendue adjustment components 105 in the diffuser wheel, and the laser light may pass through the diffuser wheel more than twice. FIG. 6 is a schematic structural diagram of another diffuser wheel according to some embodiments of the present disclosure, and FIG. 7 is a schematic structural diagram of a projection light source according to other embodiments of the present disclosure, and the projection light source shown in FIG. 7 includes the diffuser wheel shown in FIG. 6, and FIG. 6 may be a left or right view of the diffuser wheel in FIG. 7. Combined with FIG. 6 and FIG. 7, and based on FIGS. 4 and 5, the projection light source 10 may also include a second optical path guiding element 103. The two second optical path guiding elements 103 are disposed on different sides of the diffuser wheel, respectively. For ease of differentiation, the second optical path guiding element 103, which is the same as the second optical path guiding element 103 in FIG. 5, is labeled 103a in FIG. 7, and the second optical path guiding element 103, which is included based on FIG. 5, is labeled 103b. The second optical path guiding element 103a guides the laser light to be emitted through the corresponding second etendue adjustment component 105 (e.g., the second region Q2 therein), and the laser light can be further guided to pass through the corresponding second etendue adjustment component 105 (e.g., the third region Q3 therein) to be diffused again, such that the laser light can be diffused through the diffuser wheel three times, which can further enhance the effect on reducing speckles. It should be noted that FIG. 6 does not illustrate the regional division of the individual etendue adjustment component in the diffuser wheel.

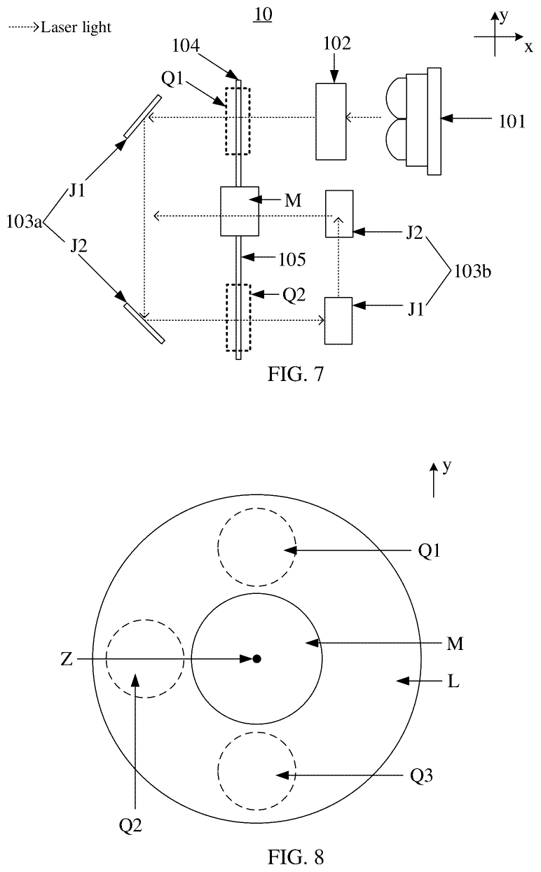

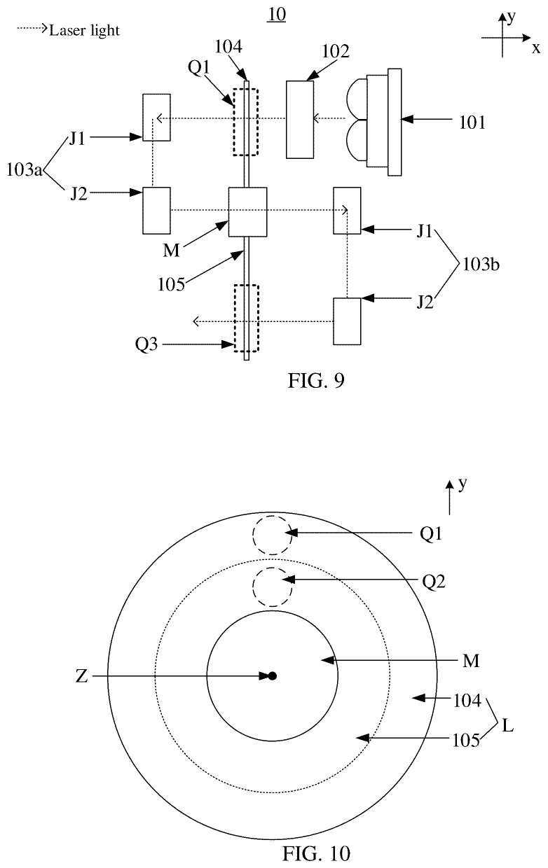

FIGS. 6 and 7 take the case as an example where the first region Q1 and the second region Q2 are located on opposite sides of the rotational shaft Z, and the third region Q3 is located between the first region Q1 and the second region Q2 in the y direction. The y direction is perpendicular to the arrangement direction of the first region Q1 and the second region Q2. In a specific embodiment, the positions of the first region Q1, the second region Q2, and the third region Q3 may also have other optional arrangements, which are only necessary to ensure that these three areas are different from each other. FIG. 8 is a schematic structural diagram of still another diffuser wheel according to some embodiments of the present disclosure, and FIG. 9 is a schematic structural diagram of another projection light source according to other embodiments of the present disclosure, the projection light source shown in FIG. 9 includes the diffuser wheel shown in FIG. 8, and FIG. 8 may be a left or right view of the diffuser wheel in the projection light source shown in FIG. 9. Combined with FIG. 8 and FIG. 9, the first region Q1 and the third region Q3 may also be located on opposite sides of the rotational shaft Z, and the second region Q2 is located between the first region Q1 and the third region Q3 in the y direction. It should be noted that FIG. 8 does not illustrate the regional division of the individual etendue adjustment components in the diffuser wheel.

In the case that the projection light source 10 includes two second optical path guiding elements 103, the laser light passes through the diffuser wheel and is ultimately emitted from the side of the diffuser wheel away from the laser device 101 (e.g., referred to as a second side), such that subsequent optical elements may be provided on the second side of the diffuser wheel. In a specific embodiment, the projection light source 10 may also include one second optical path guiding element 103, such that the laser light emitted from the third region Q3 is then directed to one second optical path guiding element 103, and is again directed by the second optical path guiding element 103 towards the fourth region of the diffuser wheel. In this way, it can ensure that the laser light passes through the diffuser wheel and is finally emitted from a side (e.g., referred to as a first side) close to the laser device 101, such that the subsequent optical elements are provided on the first side of the diffuser wheel. The number of the second optical path guiding elements 103 is not limited in the embodiments of the present disclosure.

In the embodiment of the present disclosure, the above description takes an example that each etendue adjustment component occupies the entire radial dimension of the wheel piece L in the radial direction of the diffuser wheel. For example, the wheel piece L is in a ring shape, the etendue adjustment component is in a sector-ring shape, and the ring width of the etendue adjustment component is equal to the ring width of the wheel piece L. In a specific implementation, the wheel piece L may be divided into a plurality of annular regions along the radial direction, regardless of whether the wheel piece L is in a circular shape or a ring shape. Different etendue adjustment components in the projection light source 10 may be disposed in the same annular region of the wheel piece L. Alternatively, there may be at least two etendue adjustment components in the projection light source 10, which are respectively disposed in two annular regions arranged radially in the wheel piece L. Exemplarily, FIG. 10 is a schematic structural diagram of yet another diffuser wheel according to some embodiments of the present disclosure, and FIG. 11 is a schematic structural diagram of still another projection light source according to other embodiments of the present disclosure. The projection light source shown in FIG. 11 includes the diffuser wheel shown in FIG. 10, and FIG. 10 may be a left or right view of the diffuser wheel in the projection light source shown in FIG. 11. FIG. 10 and FIG. 11 take the case as an example where the projection light source 10 includes one first etendue adjustment component 104 and one second etendue adjustment component 105, and the two etendue adjustment components are two annular regions in the wheel piece L of the diffuser wheel. For example, the first etendue adjustment component 104 is disposed in an outer ring of the wheel piece L, the second etendue adjustment component 105 is disposed in an inner ring of the wheel piece L, and the first etendue adjustment component 104 surrounds the second etendue adjustment component 105. In a specific embodiment, the second etendue adjustment component 105 may surround the first etendue adjustment component 104, which is not limited in the embodiments of the present disclosure.

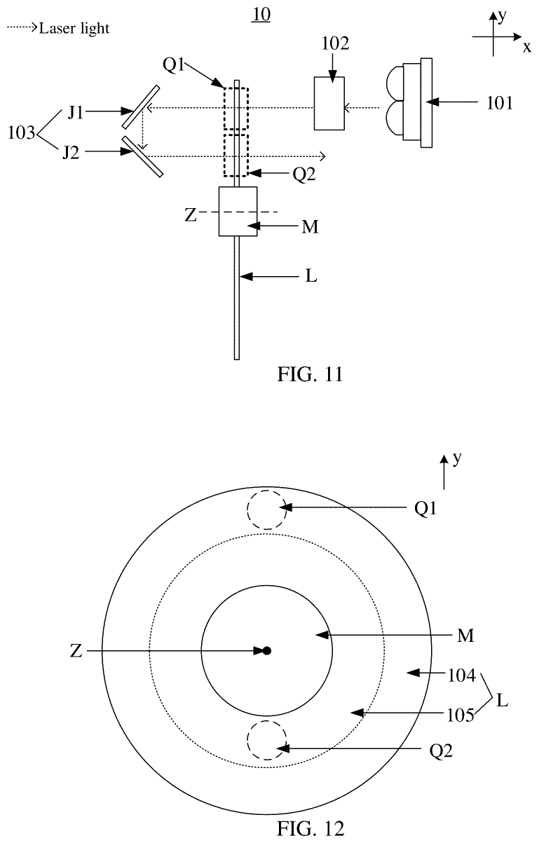

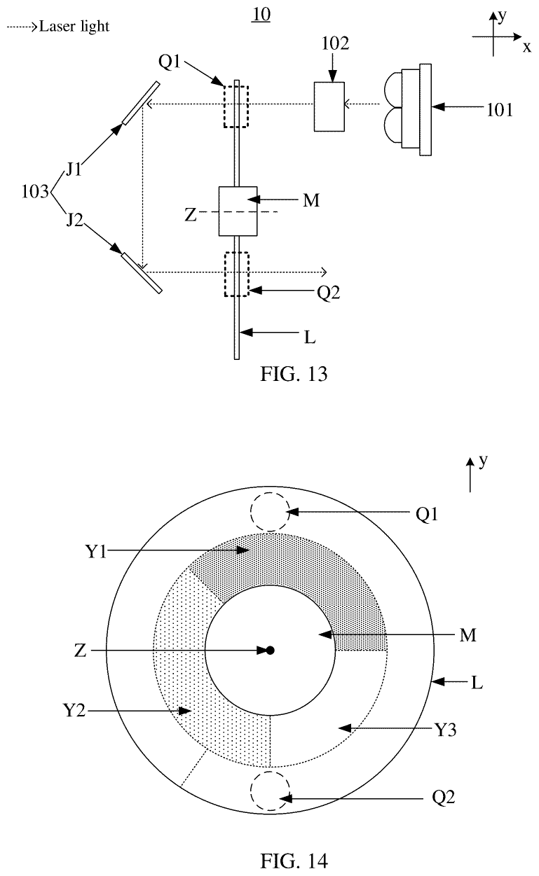

The first optical path guiding element 102 may guide the laser light to the first region Q1 in the first etendue adjustment component 104, and the laser light emitted from the first etendue adjustment component 104 is guided by the second optical path guiding element 103 to pass through the second region Q2 in the second etendue adjustment component 105. The positions of the first region Q1 and the second region Q2 are determined by the positions of the first optical path guiding element 102 and the second optical path guiding element 103. FIG. 10 and FIG. 11 take the case as an example where both the first region Q1 and the second region Q2 are located on the same side of the rotational shaft Z, and the center of the first region Q1 and the center of the second region Q2 are located in the same line with the rotational shaft Z. In a specific embodiment, FIG. 12 is a schematic structural diagram of a diffuser wheel according to other embodiments of the present disclosure, and FIG. 13 is a schematic structural diagram of yet another projection light source according to other embodiments of the present disclosure. The projection light source shown in FIG. 13 includes the diffuser wheel shown in FIG. 12, and FIG. 12 may be a left or right view of the diffuser wheel in the projection light source shown in FIG. 13. As shown in FIG. 12 and FIG. 13, the first region Q1 and the second region Q2 may also be located on opposite sides of the rotational shaft Z, respectively. In a specific implementation, the positions of the first region Q1 and the second region Q2 may also be set arbitrarily, and it is only necessary to ensure that the first region Q1 and the second region Q2 are respectively located in the two annular regions of the wheel piece L. The embodiments of the present disclosure do not limit the positions of the first region Q1 and the second region Q2, i.e., the positions of the first optical path guiding element 102 and the second optical path guiding element 103 are not limited.

All of the foregoing is based on the example that each region in the diffuser wheel is a diffusion region. In a specific implementation, the diffusion region may also occupy only a portion of the diffuser wheel, and the region in the diffuser wheel other than the diffusion region may include at least one of a fluorescence conversion region and a color filtering region.

The fluorescence conversion region may include fluorescent materials of at least one color for emitting fluorescence of a corresponding color under the excitation of the received laser light, which may also be to convert the received laser light into fluorescence. The color of the fluorescence may be different from the color of the laser light, e.g., when the laser light emitted by the laser device 101 is a blue laser light, the fluorescence may be a red fluorescence or a green fluorescence. The diffuser wheel may include a plurality of fluorescence conversion regions, and different fluorescence conversion regions are used to emit fluorescence of different colors. The laser device 101 may be a monochromatic laser device when the fluorescence conversion regions are also provided in the diffuser wheel. Since the phase of the fluorescence is more random and basically incoherent, the fluorescence conversion region is provided to convert the laser light into fluorescence to form a projection image, which can achieve a better effect on reducing speckles.

The color filtering region is used to filter the received light, such that the color purity of the light after filtering the color is higher, so as to improve the color contrast of the formed projection image and enhance the display effect of the projection image. For example, the fluorescence of each color emitted from the fluorescence conversion region can be filtered by the corresponding color filtering region, and since the fluorescence band range is larger and the purity of the fluorescence is lower, the filtered color can make the wavelength of the fluorescence in a smaller band range and improve the purity of the fluorescence.

The following takes the case as an example for introduction, where the projection light source 10 includes only one first etendue adjustment component 104 and one second etendue adjustment component 105, and the two etendue adjustment components are located in the same annular region of the diffuser wheel, and the laser light is diffused twice in the diffuser wheel.

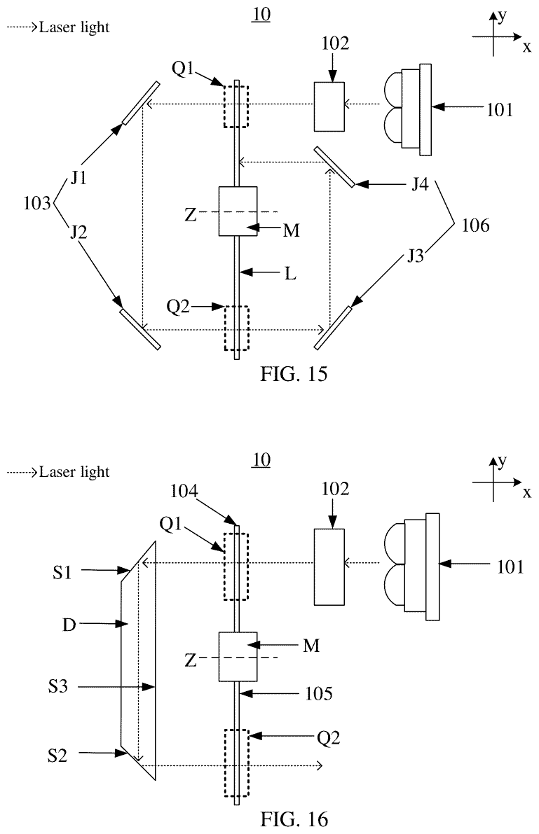

For the fluorescence conversion region, the fluorescence conversion region in the diffuser wheel may be located outside the annular region where each etendue adjustment component is located, that is, the fluorescence conversion region and each etendue adjustment component may be located in different annular regions in the diffuser wheel. FIG. 14 is a schematic structural diagram of another diffuser wheel according to other embodiments of the present disclosure, and FIG. 15 is a schematic structural diagram of a projection light source according to still other embodiments of the present disclosure. The projection light source shown in FIG. 15 includes the diffuser wheel shown in FIG. 14, and FIG. 14 may be a left or right view of the diffuser wheel in the projection light source shown in FIG. 15. As shown in FIG. 14 and FIG. 15, the diffuser wheel also includes two fluorescence conversion regions located in the same annulus, respectively a first fluorescence conversion region Y1 and a second fluorescence conversion region Y2, and the number of fluorescence conversion regions are not limited in the embodiment of the present disclosure. FIGS. 14 and 15 take the annular region where the etendue adjustment component is located to surround the annular region where the fluorescence conversion region is located as an example, and in a specific embodiment, the annular region where the fluorescence conversion region is located may also surround the annular region where the etendue adjustment component is located. Each fluorescent conversion region may be in a sector-ring shape, and different fluorescent conversion regions may have different colors. For example, the first fluorescence conversion region Y1 and the second fluorescence conversion region Y2 may be used to emit red laser light and green laser light respectively when excited by a laser light.

In a specific embodiment, continuing to refer to FIG. 14, the annular region where the fluorescence conversion region is located may also include a reflective region Y3, which is used to directly reflect the received laser light. As the diffuser wheel rotates, the reflective region and each fluorescence conversion region in the annular region may alternatively receive laser light to emit light of different colors from the diffuser wheel at different moments. For example, the laser light incident on the diffuser wheel is blue laser light. In this way, it can be ensured that red, green, and blue lights are emitted successively as the diffuser wheel rotates. In the case where a fluorescence conversion region is provided in the diffuser wheel is equivalent to integrating the diffuser wheel and the fluorescent wheel.

As shown in FIG. 15, the projection light source 10 also includes a third optical path guiding element 106, which is used to guide the laser light emitted from the second etendue adjustment component 105 to the fluorescence conversion region. In the case where the projection light source 10 includes a plurality of second etendue adjustment components 105, the third optical path guiding element may guide the laser light emitted after passing through the last second etendue adjustment component 105, such that the laser light is directed to the fluorescence conversion region after passing through all the second etendue adjustment components 105.

In a specific implementation, the fluorescence conversion region may also be located in the same annulus as the etendue adjustment component in the diffuser wheel, such as in the same annulus as the first etendue adjustment component. In this case, the laser light can still be emitted from the first etendue adjustment component after being diffused multiple times by the diffuser wheel, so as to ensure that as the diffuser wheel rotates, whether the laser light is emitted to the first etendue adjustment component or to the fluorescence conversion region, it can be collected by the subsequent light-collecting component.

For the color-filtering region, the color-filtering region in the diffuser wheel may be located outside the annular region where each etendue adjustment component is located. The color-filtering region may be provided in the manner described above with reference to the fluorescence conversion region. The laser light may first pass through the color filtering region to filter the color, and then later light diffuse through the first etendue adjustment component and the second etendue adjustment component; or the laser light may first diffuse through the first etendue adjustment component and the second etendue adjustment component, and then later filter the color through the color filtering region. Exemplarily, the laser device 101 may be a multicolor laser device, and for the laser light of each color emitted from the laser device 101, there may be one color filtering region corresponding to the laser light for filtering the color of the laser light. The laser device 101 may sequentially emit laser light of multiple colors according to a set timing, and the rotation pattern of the color filtering region in the diffuser wheel may be matched with the light-emitting timing of the laser device 101 to ensure that when the laser device 101 emits laser light of each color, the color filtering region that receives the laser light is the color filtering region corresponding to the laser light of the color.

The projection light source may also include a fourth optical path guiding element, which is used to guide the laser light to the color filtering region. In the case that the laser light is first color filtered and then diffused, the fourth optical path guiding element may guide the laser light emitted from the laser device to the color filtering region, and then the first optical path guiding element is used to guide the laser light emitted from the color filtering region to the first etendue adjustment component. In the case that the laser light is first diffused and then color filtered, the fourth optical path guiding element may guide the laser light emitted from the second etendue adjustment component to the color filtering region.

In a specific implementation, the diffuser wheel may also include both a fluorescence conversion region and a diffusion region. The fluorescence conversion region and the color filtering region may be located in different annular regions, and the fourth optical path guiding element may guide fluorescence emitted from the fluorescence conversion region to a corresponding color filtering region.

In the embodiments of the present disclosure, the structures of the second optical path-guiding element, the third optical path-guiding element, and the fourth optical path-guiding element may be the same. The structure of the optical path guiding element is described below in conjunction with the accompanying drawings.

In a first optional implementation of the optical path guiding element, continuing to refer to FIG. 5, FIG. 7, FIG. 9, FIG. 11, FIG. 13, and FIG. 15, the second optical path guiding element 103 may include two mirrors. One of the mirrors is used to receive the laser light emitted from the other etendue adjustment component and reflect the received laser light toward the other mirror. The other etendue adjustment component refers to an etendue adjustment component other than the second etendue adjustment component 105 corresponding to the second optical path guiding element 103. The other mirror is used to reflect the received laser light toward the second etendue adjustment component 105 corresponding to the second optical path guiding element 103. The mirrors in the second optical path guiding element may all be tilted and have a specific tilting direction and angle for realizing the reflection of the received laser light toward the corresponding position. Exemplarily, the second optical path guiding element 103 includes a first reflecting mirror J1 and a second reflecting mirror J2, the first reflecting mirror J1 is used to reflect the laser light received from the diffuser wheel (e.g., the first region Q1 thereof) toward the second reflecting mirror J2, and the second reflecting mirror J2 is used to reflect the received laser light toward the diffuser wheel (e.g., the second region Q2 thereof). As shown in FIG. 15, the third optical path guiding element 106 may also include two mirrors, a third reflecting mirror J3 and a fourth reflecting mirror J4, respectively. The third reflecting mirror J3 is used to reflect the laser light emitted from the second etendue adjustment component 105 toward the fourth reflecting mirror J4, and the fourth reflecting mirror J4 is used to reflect the received laser light toward the fluorescence conversion region. The structure of the fourth optical path guiding element may also be the same, which is not described in the embodiments of the present disclosure herein.

In a second optional implementation of the optical path guiding element, FIG. 16 is a schematic structural diagram of another projection light source according to still other embodiments of the present disclosure. As shown in FIG. 16, the second optical path guiding element 103 includes a light-guiding prism D. The light-guiding prism D has a light-receiving surface S3 opposite the diffuser wheel, and two light-adjusting surfaces connected to opposite sides of the light-receiving surface S3, such as the two light-adjusting surfaces being a first light-adjusting surface S1 and a second light-adjusting surface S2, respectively. The light-receiving surface S3 is used to transmit laser light received from the diffuser wheel (e.g., the first region Q1 thereof) to one of the two light-adjusting surfaces (e.g. the first light-adjusting surface S1). The first light-adjusting surface S1 is used to reflect the received laser light towards the other light-adjusting surface (e.g. the second light-adjusting surface S2). The second light-adjusting surface S2 is used to reflect the received laser light towards the light-receiving surface S3. The light-receiving surface S3 is also used to transmit the laser light received from the second light-adjusting surface S2 to the diffuser wheel (e.g., the second region Q2 thereof). The irradiation region of the laser light emitted from the diffuser wheel on the light-receiving surface S3 is different from the irradiation region of the second light-adjusting surface S2 on the light-receiving surface S3.

In the embodiments of the present disclosure, the light-guiding prism D may be used to replace any of the optical path guiding elements including two mirrors, such as the second optical path guiding element 103 in FIG. 5, FIG. 7, FIG. 9, FIG. 11, and FIG. 13 may be the light-guiding prism D, and the second optical path guiding element 103 and the third optical path guiding element 106 in FIG. 15 may be the light-guiding prism D. The embodiments of the present disclosure only take the example of replacing the second optical path guiding element in FIG. 5 with the light-guiding prism D and using FIG. 16 for illustration. Regarding the application of the light-guiding prism D in other forms of the projection light source 10, the embodiments of the present disclosure will not provide additional illustrations.

In a specific embodiment, the projection light source 10 may also include a phase conversion component for adjusting the phase of the received laser light. At least a portion of the laser light emitted from the laser device 101 may also be adjusted in phase by the phase conversion component to further optimize the effect on reducing speckles. In the case that the at least a portion of the laser light is a portion of the laser light emitted from the laser device 101 (and also a portion of all of the laser light), only the portion of the laser light may be phase-converted and diffused, and laser light other than the portion of the laser light does not pass through the phase conversion component, and is only diffused. The material of the phase conversion component may include a birefringent material. There can be various optional implementations for the phase conversion component, and the following will introduce two of the optional implementations as examples.

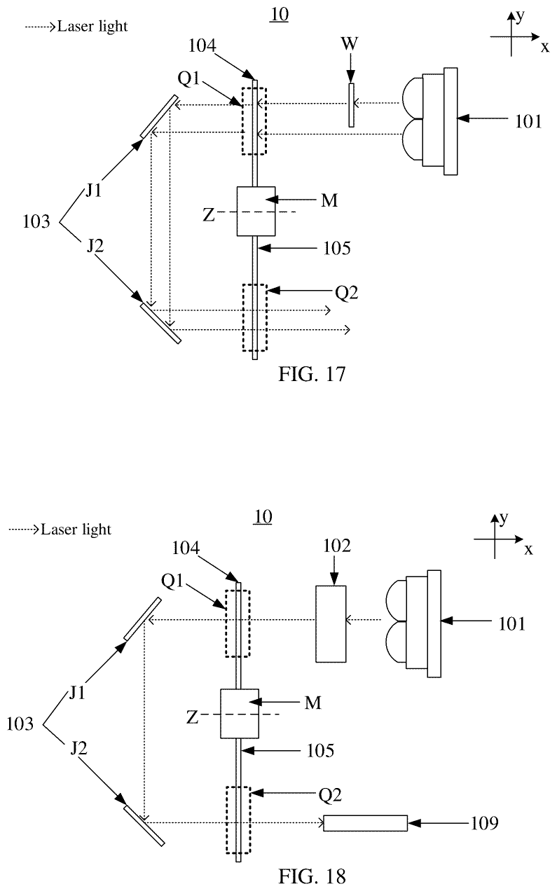

In a first optional implementation of the phase conversion component, FIG. 17 is a schematic structural diagram of yet another projection light source according to still other embodiments of the present disclosure. As shown in FIG. 17, the first optical path guiding element 102 may include a phase conversion component W, and FIG. 17 is illustrated with an example of the first optical path guiding element 102 including only the phase conversion component W. The phase conversion component W may be disposed between the laser device 101 and the diffuser wheel, and is independent of the diffuser wheel, and the laser light directed to the phase conversion component W is directed to the first etendue adjustment component 104 in the diffuser wheel after passing through the phase conversion component W. It should be noted that the projection light source 10 may include the phase conversion component W based on any of the above-mentioned structures, and the embodiments of the present disclosure only take the projection light source 10 in FIG. 5 as an example for illustration. In the embodiments of the present disclosure, the introduction of the positional relationships among various components in the projection light source 10 is all about the positional relationships in terms of the transmission path of the laser light, and the positional relationship may have a certain difference from the actual positional relationship in space. For example, when one component is located between two other components, it means that the time when the laser light is incident on this one component is between the times when the laser light is incident on the two other components; and when one component is located before (or after) another component, it means that the time when the laser light passes through another component is earlier (or later) than the time when the laser light is incident on this one component.

The phase conversion component W may be disposed on the transmission path of only a portion of the laser light emitted from the laser device 101, and only the portion of the laser light emitted from the laser device 101 passes through the phase conversion component W to the diffuser wheel. For example, an orthographic projection of the phase conversion component W on the light-output surface of the laser device 101 covers only a portion of the light-output region in the light-output surface, only the portion of the laser light emitted from the portion of the light-output region may be directed to the phase conversion component W. The phase conversion component W may adjust the phase of the laser light received, such that the phase of the laser light is different from that of the laser light that has not passed through the phase conversion component W. In this way, after passing through the phase conversion component W, the laser light can have two different phases, which increases the difference of the laser light. Consequently, it can reduce the coherence between the laser light, which is helpful for reducing the speckle effect.

The phase conversion component W may be stationary with respect to the laser device 101. Exemplarily, the phase conversion component W may include a wave plate, such as a half-wave plate or a quarter-wave plate. For example, the phase conversion component W includes a half-wave plate, the laser light may be polarized light that is orthogonal in phase after passing through the phase conversion component W, with a large phase difference between the laser light. In a specific embodiment, the phase conversion part piece W may also move relative to the laser device 101, such as translating back and forth in a certain direction or rotating around a certain direction. At this time, all of the laser light emitted from the laser device 101 may be directed to the phase conversion component W, or may still be directed partially to the phase conversion component W. When the phase conversion component W is rotated, the angle between the laser light incident on the wave plate and the optical axis of the wave plate varies continuously, e.g., it may be varied between 0 and 360 degrees. Consequently, the received laser light can be converted into unpolarized light. There is a phase difference in the unpolarized light, which may also increase the phase between the laser light, achieving the effect of reducing the speckle effect.

In a second optional implementation of the phase conversion component, the phase conversion component may be fixed to the diffuser wheel, the phase conversion component may cover at least a portion of the diffuser wheel, such as covering the diffusion region of the diffuser wheel, and the phase conversion component may rotate with the rotation of the diffuser wheel. For such optional implementation, continuing to refer to FIG. 5, FIG. 7, FIG. 9, FIG. 11, FIG. 13, and FIG. 15, and the embodiments of the present disclosure will not be illustrated by additional accompanying drawings. The phase conversion component W may be a wave plate, such as a half-wave plate or other wave plate. For example, the phase conversion component covers a portion of the diffuser wheel, and the unpolarized light is emitted alternately with the line-polarized light, which can increase the phase difference of the laser light in time. For example, the phase conversion component covers all of the diffuser wheel, the laser light can all be converted to the unpolarized light.

Exemplarily, in the case that the wheel pieces in the diffuser wheel include a carrier sheet and a diffuser sheet, the phase conversion component W may be disposed on a side of the carrier sheet away from the diffuser sheet, fixed to the carrier sheet. Alternatively, the phase conversion component W may be disposed on a side of the diffuser sheet away from the carrier sheet, fixed to the diffuser sheet. For example, the wheel piece in the diffuser wheel includes only the diffuser sheet, the phase conversion component W may be directly fixed to that diffuser sheet. In a specific embodiment, the phase conversion component W may be fixed to the diffuser wheel by attachment or coating.

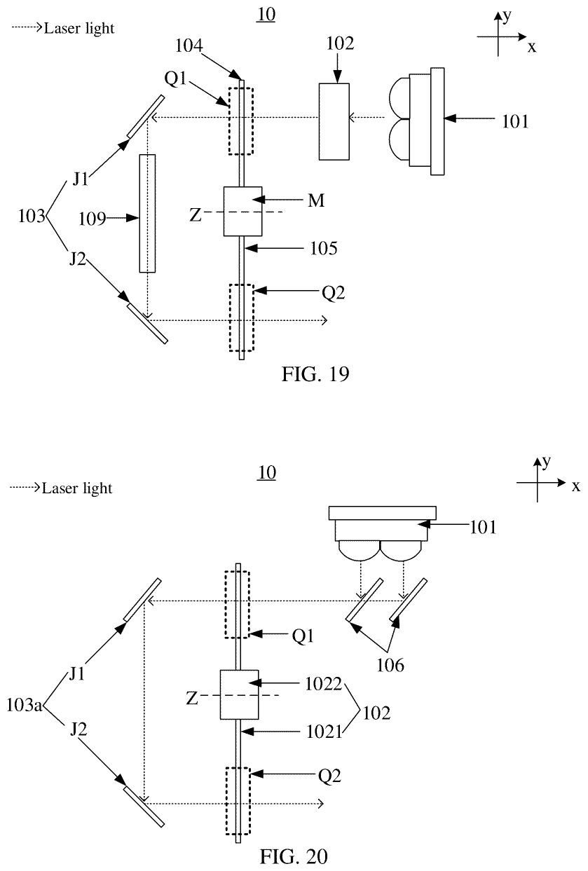

In the embodiments of the present disclosure, the projection light source 10 may also include a homogenizing-shaping component. FIG. 18 is a schematic structural diagram of yet another projection light source according to still other embodiments of the present disclosure, and FIG. 19 is a schematic structural diagram of a projection light source according to yet other embodiments of the present disclosure. As shown in FIG. 18, based on FIG. 5, the projection light source 10 may also include a homogenizing-shaping component 109, and the homogenizing-shaping component 109 is used to homogenize and shape the received laser light and then emit the laser light. Shaping the laser light also means that the laser light spot formed by the laser light is in a set shape, such as a rectangle. The homogenization and shaping of the laser light can be more conducive to the subsequent use of the laser light. For example, the homogenizing-shaping component 109 may be a light pipe or other components for homogenizing and shaping the laser light. It should be noted that the projection light source 10 may include the homogenizing-shaping component 109 based on any of the above-mentioned structures, and the embodiments of the present disclosure only take the projection light source 10 in FIG. 5 as an example for illustration.

As shown in FIG. 18, the homogenizing-shaping component 109 may be disposed after the diffuser wheel, and the laser light is directed to the homogenizing-shaping component 109 after passing through the diffuser wheel several times. As shown in FIG. 19, the second optical path guiding element 103 includes two mirrors (mirrors J1 and J2), and the homogenizing-shaping component 109 may be disposed between the two mirrors. In the case where the projection light source 10 includes a plurality of second optical path guiding elements, the homogenizing-shaping component 109 may be disposed between the two mirrors of any of the second optical path guiding elements.

In the embodiment of the present disclosure, the laser device 101 may be a multi-color laser device, and the laser device 101 may emit multiple colors of laser light. FIG. 20 is a schematic structural diagram of another projection light source according to yet other embodiments of the present disclosure. As shown in FIG. 20, based on any of the above-described projection light sources 10 (such as the projection light source 10 shown in FIG. 5), the first optical path guiding element 102 may include a light-combining component H. The light-combining component H may combine the multi-colored laser light emitted from the laser device 101 and then emit the combined laser light to the first etendue adjustment component. Exemplarily, the light-combining component H may be a light-combining mirror group including a plurality of light-combining lenses. Different light-emitting regions in the laser device 101 emit laser light of different colors, and each light-combining lens may correspond to one light-emitting region, and each light-combining lens reflects the laser light emitted from the corresponding light-emitting region in the same direction (e.g., the opposite direction of the x direction in FIG. 20), so as to achieve the combination of the laser light of various colors emitted from the laser device 101. Exemplarily, the rearward light-combining lens of the plurality of light-combining lenses may be a dichroic mirror, which is used to reflect one type of laser light emitted from the laser device 101 and transmit the laser light emitted from the light-combining lens in front thereof. In a specific embodiment, the laser device 101 may also be a monochromatic laser device, and the laser light emitted from the laser device 101 may be reduced in beam diameter by the light-combining component H.

In an optional implementation of the laser device 101, the laser device 101 may be a multi-chip laser diode (multichip Laser Diode, MCL)-type laser device, and the MCL-type laser device may include a plurality of light-emitting chips encapsulated in the same package arranged in an array, and each of the light-emitting chips may emit laser light independently. For example, the laser device 101 is used to emit a red, green, and blue laser, the light-combining component H may include three light-combining lenses corresponding to the laser light of the three colors, respectively. The laser device 101 may include 28 light-emitting chips arranged in four rows and seven columns, wherein two rows are red light-emitting chips, and one row of the other two rows is green light-emitting chips and one row is blue light-emitting chips. The arrangement and number of light-emitting chips in the laser device 101 can also be adjusted arbitrarily, which are not limited in the embodiments of the present disclosure.

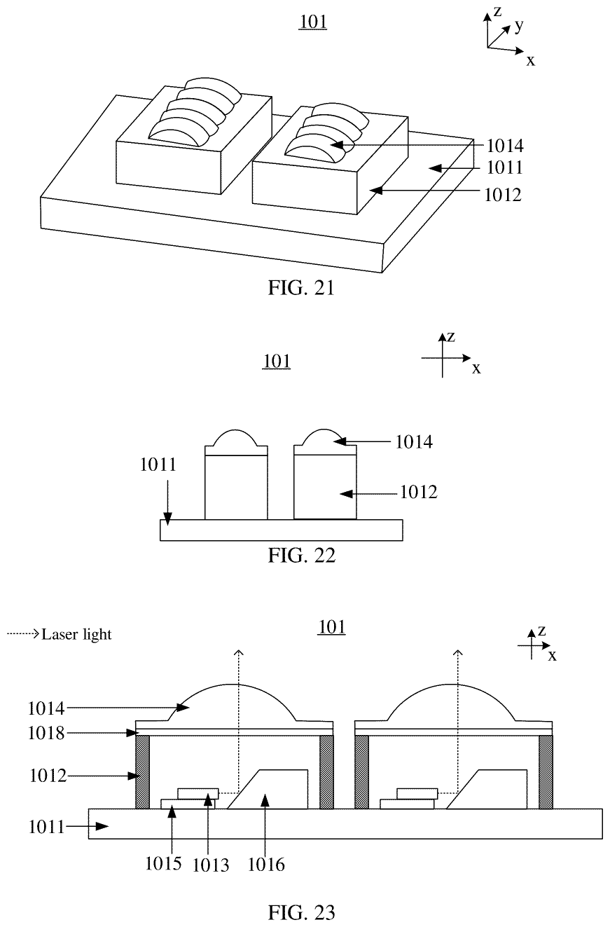

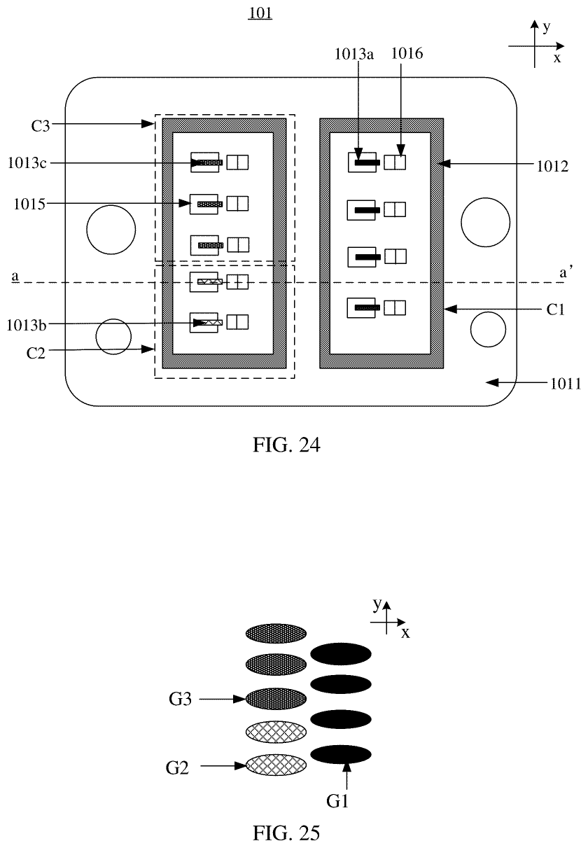

In another optional implementation of the laser device 101, FIG. 21 is a schematic structural diagram of a laser device according to some embodiments of the present disclosure, FIG. 22 is a schematic structural diagram of another laser device according to some embodiments of the present disclosure, FIG. 23 is a schematic structural diagram of still another laser device according to some embodiments of the present disclosure, FIG. 24 is a schematic structural diagram of yet another laser device according to some embodiments of the present disclosure, FIG. 22 and FIG. 23 may be a front view of the laser device shown in FIG. 21, and FIG. 24 may be a top view of the laser device shown in FIG. 21. As shown in FIGS. 21 to 24, the laser device 101 may include a base plate 1011 and two light-emitting modules (not labeled in the drawings). Both light-emitting modules are disposed on the base plate 1011, and the two light-emitting modules may be sequentially arranged along a first direction (e.g., the x direction). Each light-emitting module may include a ring-shaped tube wall 1012 and a plurality of light-emitting chips 1013 surrounded by the tube wall 1012. In a specific embodiment, each light-emitting module may be in a long strip shape, and an orthographic projection of each light-emitting module on the base plate 1011 may be approximately rectangular. The length direction of the rectangle maybe parallel to a second direction (e.g., the y direction) and the width direction parallel to the first direction. The plurality of light-emitting chips 1013 in each light-emitting module may be arranged in at least one row along the first direction. The embodiments of the present disclosure take the plurality of light-emitting chips to be arranged in only one row as an example. In a specific embodiment, the plurality of light-emitting chips may also be arranged in more than one row, such as two rows or three rows, which are not limited in the embodiments of the present disclosure.

Each light-emitting module may also include a collimating lens group 1014, a plurality of heat sinks 1015, a plurality of reflecting prisms 1016, and a light-transmitting sealing layer 1018. The plurality of heat sinks 1015 and the plurality of reflecting prisms 1016 may be in one-to-one correspondence with the plurality of light-emitting chips 1013 in the light-emitting module. Each light-emitting chip 1013 is disposed on the corresponding heat sink 1015, and the heat sink 1015 is used to assist in heat dissipation of the corresponding light-emitting chip 1013. The material of the heat sink 1015 may include ceramic. Each reflecting prism 1016 is disposed on a light-output side of the corresponding light-emitting chip 1013. The light-transmitting sealing layer 1018 is disposed on a side of the tube wall 1012 away from the base plate 1011 for sealing an opening on the side of the tube wall 1012 away from the base plate 1011, so as to enclose a sealed space together with the base plate 1011 and the tube wall 1012. In a specific embodiment, the laser device 101 may not include the light-transmitting sealing layer 1018, and instead, the collimating lens group 1014 is directly fixed to the surface of the tube wall 1012 away from the base plate 1011. In this way, the collimating lens group 1014 encloses the sealed space with the tube wall 1012 and the base plate 1011.

The collimating lens group 1014 is disposed on a side of the light-transmitting sealing layer 1018 away from the base plate 1011. The collimating lens group 1014 includes a plurality of collimating lenses (not shown in the drawings) in one-to-one correspondence with the plurality of light-emitting chips 1013. In the embodiments of the present disclosure, each collimating lens in each collimating lens group 1014 may be integrally formed. Exemplarily, the collimating lens group 1014 is substantially plate-shaped, a side of the collimating lens group 1014 close to the base plate 1011 is a flat surface, a side away from the base plate 1011 has a plurality of convex arc surfaces, and each portion where a convex arc surface is located in the plurality of convex arc surfaces is a collimating lens.

The light-emitting chip 1013 may emit laser light to a corresponding reflecting prism 1016, and the reflecting prism 1016 may reflect the laser light in a direction (e.g., z direction) away from the base plate 1011 toward a collimating lens corresponding to the light-emitting chip 1013 in the collimating lens group 1014, such that the laser light may be collimated by the collimating lens and then emitted.

In the embodiments of the present disclosure, the light-emitting chips 1013 in different light-emitting modules in the laser device 101 may be used to emit laser light of different colors. It should be noted that the light-emitting chips may be divided according to the light-emitting color, each type of light-emitting chips may emit laser light of one color, and the different types of light-emitting chips are used to emit laser light of different colors. In the embodiments of the present disclosure, different light-emitting modules in the laser device 101 may include different types of light-emitting chips. Each light-emitting module may include only one type of light-emitting chips, or there may exist a light-emitting module including multiple types of light-emitting chips.

Exemplarily, the laser device 101 may include three light-emitting regions, the three light-emitting regions being used to emit laser light of three colors respectively. For example, the three light-emitting regions include a first light-emitting region C1, a second light-emitting region C2, and a third light-emitting region C3. The laser device 101 may include a first light-emitting module and a second light-emitting module. The first light-emitting module may be a light-emitting module disposed on the left side of the figure, and the second light-emitting module may be a light-emitting module disposed on the right side of the figure. The first light-emitting module may include a plurality of first-type light-emitting chips 1013a, and the second light-emitting module may include a plurality of second-type light-emitting chips 1013b and a plurality of third-type light-emitting chips 1013c. For example, the first-type light-emitting chips 1013a are used to emit red laser light, the second-type light-emitting chips 1013b are used to emit blue laser light, and the third-type light-emitting chips 1013c are used to emit green laser light.

In the embodiments of the present disclosure, the first light-emitting region C1 of the laser device 101 may be a region where the first light-emitting module is located, the second light-emitting region C2 is a region where the second-type of light-emitting chip 1013b is located in the region where the second light-emitting module is located, and the third light-emitting region C3 is a region where the third-type of light-emitting chip 1013c is located in the region where the second light-emitting module is located. In a specific implementation, the laser device 101 may include only one tube wall 1012, and the plurality of light-emitting chips 1013 in the laser device 101 may be arranged in multiple rows and columns in the one tube wall 1012. The arrangement of the plurality of light-emitting chips 1013 may be the same as the arrangement of the light-emitting chips 1013 in FIG. 24, which is not repeated in the embodiments of the present disclosure. In this kind of laser device 101, each light-output region is a region where various types of light-emitting chips are located.

The embodiments of the present disclosure take the first light-emitting region C1 including four light-emitting chips 1013a arranged in a first direction, the second light-emitting region C2 including two light-emitting chips 1013b arranged in the first direction, and the third light-emitting region C3 including three light-emitting chips 1013c arranged in the first direction as an example. Each light-emitting chip can emit a small beam of laser light to form a sub-light spot, and thus the laser light emitted from the first light-emitting region C1 can form four sub-light spots G1 arranged in the first direction, the laser light emitted from the second light-emitting region C2 can form two sub-light spots G2 arranged in the first direction, and the laser light emitted from the third light-emitting region C3 can form three sub-light spots G3 arranged in the first direction. FIG. 25 is a schematic diagram of a light spot formed by laser light emitted from a laser device according to some embodiments of the present disclosure.

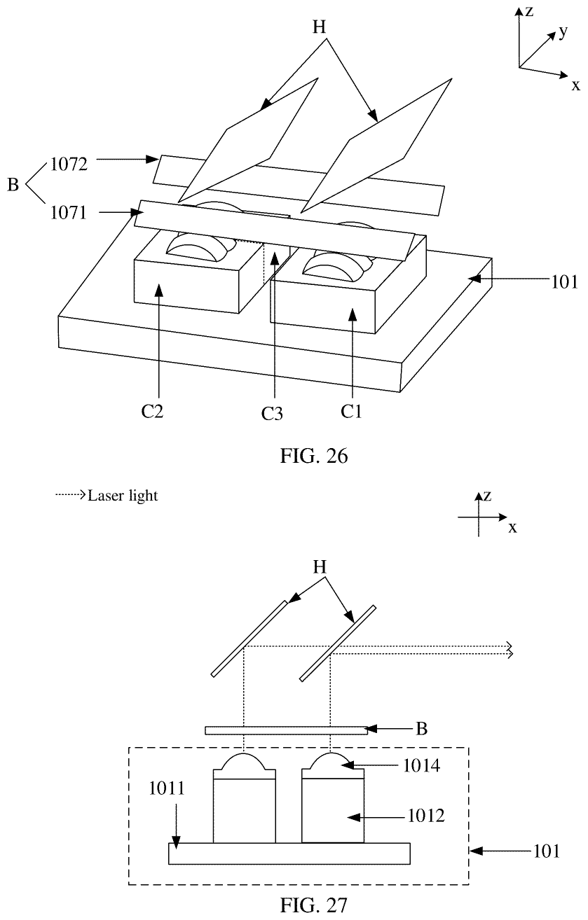

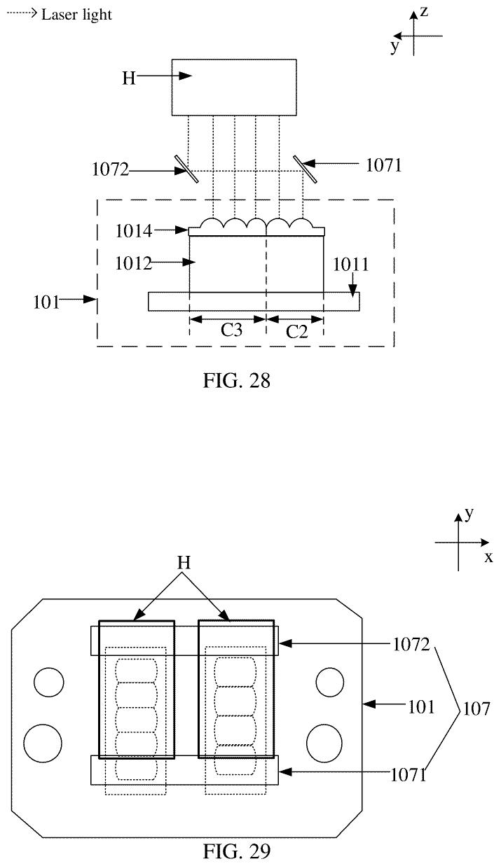

FIG. 26 is a partial schematic structural diagram of a projection light source according to some embodiments of the present disclosure, FIG. 27 is a schematic structural diagram of a portion of another projection light source according to some embodiments of the present disclosure, FIG. 28 is a schematic structural diagram of a portion of still another projection light source according to some embodiments of the present disclosure, and FIG. 29 is a schematic structural diagram of a portion of yet another projection light source according to some embodiments of the present disclosure. FIG. 27 may be a front view of the structure shown in FIG. 26, FIG. 28 may be a left view of the structure shown in FIG. 26, and FIG. 29 may be a top view of the structure shown in FIG. 26. As shown in FIGS. 26 to 29, the first optical path guiding element 102 in the projection light source 10 may also include: a light-adjusting structure B. The light-adjusting structure B includes a first light-adjusting mirror 1071 and a second light-adjusting mirror 1072 arranged in sequence along the second direction.

A portion of the region in the second light-emitting region C2 located at an end away from the third light-emitting region C3 may be a second sub-region (not shown in the drawings), and a portion of the region in the first light-emitting region Q1 located at the end is a first sub-region (not shown in the drawings). The first sub-region and the second sub-region are the portion of the first light-emitting region C1 and the portion of the second light-emitting region C2 located at the same end, respectively. In a specific embodiment, the first sub-region and the second sub-region may be aligned in the first direction. For example, the first sub-region is aligned in the first direction with an end of the second sub-region close to other regions in the light-emitting region. The areas of the first sub-region and the second sub-region may be equal or not equal, which are not limited in the embodiments of the present disclosure. Exemplarily, the first sub-region in the first light-emitting region C1 may be a region where a portion of the first-type light-emitting chips 1013a in the first light-emitting module is located at one end. The second sub-region in the second light-emitting region C2 may be a region where a portion of the second-type light-emitting chip 1013b in the second light-emitting module is located at one end.

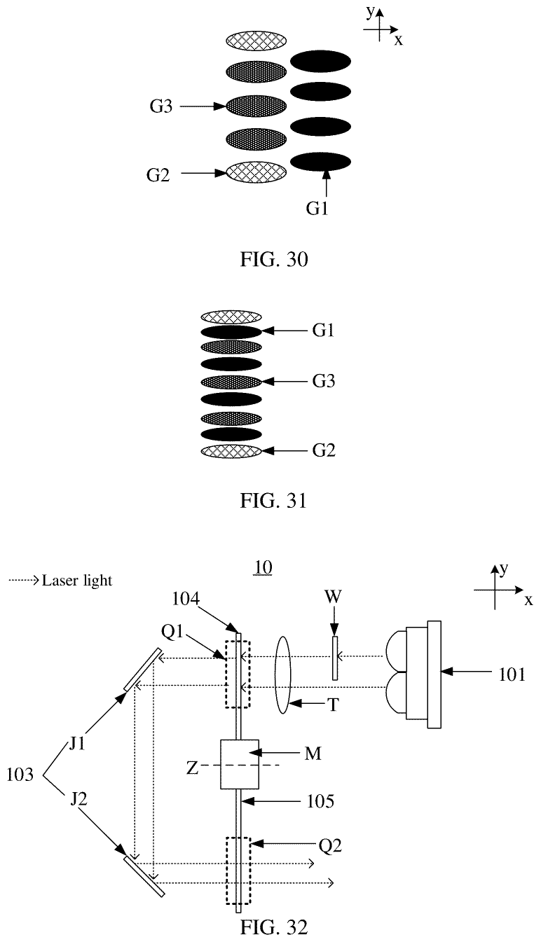

An orthographic projection of the first light-adjusting mirror 1071 on the laser device 101 covers the first sub-region in the first light-emitting region C1 and the second sub-region in the second light-emitting region C2. An orthographic of the second light-adjusting mirror 1072 on the laser device 101 is located outside of the third light-emitting region C3 and on the side of the third light-emitting region C3 away from the second light-emitting region C2. The laser light emitted from the first sub-region and the second sub-region may both be directed to the first light-adjusting mirror 1071, the first light-adjusting mirror 1071 is used to reflect the incident laser light toward the second light-adjusting mirror 1072 in the second direction, and the second light-adjusting mirror 1072 is used to reflect the incident laser light toward the light-combining component H. The laser light emitted from the region outside the first sub-region in the first light-emitting region C1 may be directed toward the light-combining component H, and the laser light emitted from the region outside the second sub-region in the second light-emitting region C2 and the laser light emitted from the third light-emitting region C3 may be directed to the light-combining component H. Afterwards the light-combining component H may combine the received laser light. FIG. 30 is a schematic diagram of a light spot formed by a laser light directed to a light-combining component according to some embodiments of the present disclosure. Compared with FIG. 25 and FIG. 30, it can be seen that the light-adjusting structure B may adjust one light spot G1 and one light spot G2 located at the edge to the other end. In this way, the symmetry of the three types of light spots can be improved. Furthermore, the consistency of the light-combining spot diffusion effect can be enhanced, and at the same time, the diffusion efficiency can also be increased. FIG. 31 is a schematic diagram of a light spot formed by a laser light emitted from a light-combining component according to some embodiments of the present disclosure.

The first light-adjusting mirror 1071 and the second light-adjusting mirror 1072 may both be rectangular, and the length direction of the rectangle may be parallel to the first direction. Both the first light-adjusting mirror 1071 and the second light-adjusting mirror 1072 may be arranged obliquely, with the first light-adjusting mirror 1071 being parallel to the second light-adjusting mirror 1072. The second light-adjusting mirror 1072 and the first light-adjusting mirror 1071 are disposed on the same side of the laser device 101 to ensure that the first light-adjusting mirror 1071 can reflect the laser light emitted from the laser device 101 to the first light-adjusting mirror 1071 toward the second light-adjusting mirror 1072. e.g., the angle of the first light-adjusting mirror 1071 and the second light-adjusting mirror 1072 with the second direction may both be 45 degrees, and the angle with the third direction may also both be 45 degrees.

The light-adjusting mirrors in embodiments of the present disclosure may be made of metal or may be obtained by coating a transparent lens with a reflective film. In a specific embodiment, the light-adjusting mirror may also be a dichroic mirror. It is only necessary to ensure that the light-adjusting mirror can emit the incident laser light in the desired direction, and no consideration is given to whether the laser light of other colors can be transmitted.

In a specific implementation, since the laser light will be diffused to some extent during the transmission process, the projection light source 10 in the embodiment of the present disclosure may also include a focusing lens to narrow the angle of the laser light during transmission. FIG. 32 is a schematic structural diagram of yet another projection light source according to yet other embodiments of the present disclosure. As shown in FIG. 32, the focusing lens 108 in the projection light source 10 may be located before the diffuser wheel. FIG. 32 takes the example that the first optical path guiding element 102 in the projection light source 10 also includes a focusing lens T based on FIG. 17, and the focusing lens T may be located between the phase conversion component W and the first etendue adjustment component (e.g., the first region Q1 in the diffuser wheel). In a specific implementation, the focusing lens T may also be disposed between the diffuser wheel and the second optical path guiding element 103, such as between the second lens J2 and the diffuser wheel, or in other positions, which is not limited in the embodiments of the present disclosure.

In summary, in the projection light source provided by the embodiments of the present disclosure, laser light emitted from a laser device can be guided by a first optical path guiding element to a first etendue adjustment component, so as to cause the laser light to increase a first etendue under the action of the first etendue adjustment component. A second optical path guiding element can guide laser light emitted from other etendue adjustment components (e.g., the first etendue adjustment component or other second etendue adjustment components) to a corresponding second etendue adjustment component, so as to cause the laser light to increase a second etendue under the action of the second etendue adjustment component. In this way, the laser light emitted from the laser device can undergo at least two increases in etendue, such that the coherence of the laser light can be largely eliminated, the speckle phenomenon of the projection image formed based on the laser light can be weakened, and the display effect of the projection image can be improved. Moreover, both the first etendue adjustment component and the second etendue adjustment component are moving components. In this way, the laser light directed to the same etendue adjustment component at different moments can be directed to different positions of the etendue adjustment component, which can weaken the coherence of the laser light in the time dimension and has a good effect on reducing speckles of the projection image formed based on the laser light.

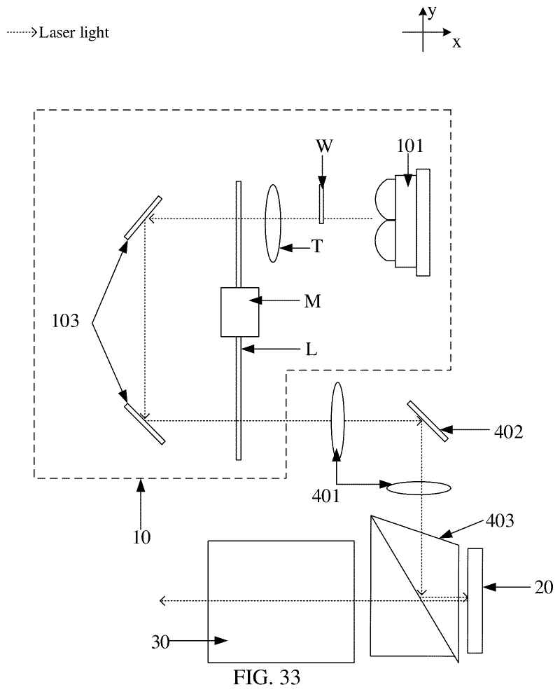

Embodiments of the present disclosure also provide a projection device. The projection device includes a projection light source, a light valve, and a lens. The projection light source may be any of the above-mentioned projection light sources, such as any of the projection light sources 10 of FIGS. 1 to 3, 5, 7, 9, 11, 13, 15 to 20, and 32. FIG. 33 is a schematic structural diagram of a projection device according to some embodiments of the present disclosure. As shown in FIG. 33, the projection device may include any of the above-mentioned projection light sources 10 (such as the projection light source 10 shown in FIG. 32), and may also include a light valve 20 and a lens 30. The projection device 10 may also include an illumination system (not shown in the drawings) disposed between the projection light source 10 and the light valve 20. The laser light emitted from the projection light source 10 can be directed towards the light valve 20 through the illumination system, which is used to modulate the received laser light and then directed it towards the lens 30, which is used to project the received laser light to form a projection image.

As shown in FIG. 33, the illumination system may include a lens group 401, a reflective mirror 402, and a total internal reflection (TIR) prism 403. The reflective mirror 402 can fold the optical path to ensure that the projection device has a relatively small volume. In some embodiments, the optical valve 20 may be a digital micromirror device (DMD). In some embodiments, the light valve 20 may also be a liquid crystal on silicon (LCOS). The light valve 20 may include a plurality of reflective sheets, each of which can be used to form a pixel in the projection image. The light valve 20 can, according to the image to be displayed, make the reflective sheets corresponding to the pixels that need to be displayed in a bright state reflect the laser light to the lens 30, so as to achieve the modulation of the laser light. The lens 30 may include a plurality of lenses (not shown in the drawings). The laser light emitted from the light valve 20 can pass through the plurality of lenses in the lens 30 successively and then be emitted.

In summary, in the projection device provided by the embodiments of the present disclosure, the phase differences of the laser light emitted by the projection light source are relatively large, and the mixing effect is relatively good. Therefore, the speckle phenomenon of the projection image formed based on the laser light emitted by the projection light source is relatively weak, and the color uniformity of the projection image can be relatively high, resulting in a better display effect of the projection image.

1. A projection light source, comprising: a laser device, at least one optical path guiding element, a first etendue adjustment component, and a second etendue adjustment component; wherein
the laser device is configured to emit laser light of at least two colors;
each of the at least one optical path guiding element is configured to combine the laser light of at least two colors emitted from the laser device and guide a laser beam to the first etendue adjustment component or the second etendue adjustment component; and
at least one of the first etendue adjustment component and the second etendue adjustment component is a moving component, wherein the first etendue adjustment component is configured to increase a first etendue of incident laser light and then emit the laser light that has increased the first etendue; and the second etendue adjustment component is in an output optical path of the first etendue adjustment component and is configured to increase a second etendue of incident laser light and then emit the laser light that has increased the second etendue.

2. The projection light source according to claim 1, wherein any of etendue adjustment components in the projection light source is a transmissive diffuser or a reflective diffuser.

3. The projection light source according to claim 1, wherein the moving component performs a rotational movement or a translational movement.

4. The projection light source according to claim 1, wherein the first etendue adjustment component and the second etendue adjustment component are both moving components.

5. The projection light source according to claim 4, wherein a movement of the first etendue adjustment component and a movement of the second etendue adjustment component are not synchronized.

6. The projection light source according to claim 1, wherein the at least one optical path guiding element comprises a first optical path guiding element and a second optical path guiding element; wherein
the first optical path guiding element is configured to combine the laser light of at least two colors emitted from the laser device and guide a laser beam to the first etendue adjustment component; and
the number of second optical path guiding elements and the number of second etendue adjustment components are both greater than or equal to one, wherein each of the second optical path guiding elements corresponds to one of the second etendue adjustment components, and is configured to receive a laser beam emitted from an etendue adjustment component other than a corresponding second etendue adjustment component and guide the received laser beam to the corresponding second etendue adjustment component.

7. The projection light source according to claim 6, wherein the first optical path guiding element is configured to combine blue laser light, green laser light, and red laser light emitted from the laser device, and is capable of guiding the laser beam to the first etendue adjustment component before or after combining.

8. The projection light source according to claim 6, further comprising a phase conversion component, wherein the phase conversion component is configured to phase the received laser light; and
the first optical path guiding element comprises the phase conversion component, wherein the phase conversion component is stationary with respect to the laser device, and a portion of laser light emitted from the laser device is directed to the first etendue adjustment component through the phase conversion component; or,
each of etendue adjustment components in the projection light source is a diffusion region in a diffuser wheel, wherein the phase conversion component is fixed to the diffuser wheel, the phase conversion component covers at least a portion of a region in the diffuser wheel, and the phase conversion component rotates with a rotation of the diffuser wheel.

9. The projection light source according to claim 6, wherein the first optical path guiding element comprises a light-combining component, wherein the laser device is configured to emit laser light of a plurality of colors, and the light-combining component is configured to combine the laser light of the plurality of colors and then emit the combined laser light; and/or,
the projection light source further comprises a homogenizing-shaping component, wherein laser light is directed to the homogenizing-shaping component after passing through each of the second etendue adjustment components, or any of the second optical path guiding elements comprises two mirrors, the homogenizing-shaping component being disposed between the two mirrors; and the homogenizing-shaping component is configured to homogenize and shape the received laser light and then emit the laser light.

10. The projection light source according to claim 6, wherein for any of the second optical path guiding elements and the corresponding second etendue adjustment component:
the second optical path guiding element comprises two mirrors, wherein one of the mirrors is configured to reflect laser light received from one etendue adjustment component other than the second etendue adjustment component towards another mirror, and the another mirror is configured to reflect the received laser light towards the second etendue adjustment component; or,
the second optical path guiding element comprises a light-guiding prism having a light-receiving surface and two light-adjusting surfaces connected to opposite sides of the light-receiving surface, wherein the light-receiving surface is configured to transmit laser light received from one etendue adjustment component other than the second etendue adjustment component to one of the two light-adjusting surfaces, the one of the two light-adjusting surfaces is configured to reflect the received laser light towards another light-adjusting surface, the another light-adjusting surface is configured to reflect the received laser light towards the light-receiving surface, and the light-receiving surface is further configured to transmit the received laser light from the another light-adjusting surface towards the second etendue adjustment component.

11. The projection light source according to claim 1, wherein each of etendue adjustment components in the projection light source is configured to rotate around a same rotational shaft; and in a plane perpendicular to the rotational shaft, an orthographic projection of at least a portion of each of the etendue adjustment components is outside an orthographic projection of other etendue adjustment components.

12. The projection light source according to claim 11, wherein the rotational shaft is a rotational shaft of a diffuser wheel; and
different etendue adjustment components in the projection light source are different annular-sector regions or sector-shaped regions in a circumferential direction of the diffuser wheel; or at least two etendue adjustment components in the projection light source are in two annular regions arranged radially in the diffuser wheel.

13. The projection light source according to claim 12, wherein the diffuser wheel further comprises a fluorescence conversion region disposed outside the annular regions where each of the etendue adjustment components is located, wherein the fluorescence conversion region is configured to convert the received laser light into fluorescence and emit the fluorescence; and the projection light source further comprises a third optical path guiding element, wherein the third optical path guiding element is configured to guide laser light emitted from the second etendue adjustment component to the fluorescence conversion region; and/or,
the diffuser wheel further comprises a color filtering region, wherein the color filtering region is configured to emit the received laser light after color filtering, and the color filtering region is located outside the annular regions where each of etendue adjustment components is located; and the projection light source further comprises a fourth optical path guiding element, wherein the fourth optical path guiding element is configured to guide laser light emitted from the laser device to the color filtering region, and the first optical path guiding element is configured to guide laser light emitted from the color filtering region to the first etendue adjustment component, or the fourth optical path guiding element is configured to guide laser light emitted from the second etendue adjustment component to the color filtering region.

14. A projection device, comprising: a projection light source, a light valve, and a lens; wherein
the projection light source is configured to emit laser light to the light valve, the light valve is configured to modulate the received laser light and then emit the modulated laser light to the lens, and the lens is configured to project the received laser light to form a projection image; and
the projection light source comprises a laser device, at least one optical path guiding element, a first etendue adjustment component, and a second etendue adjustment component; wherein
the laser device is configured to emit laser light of at least two colors;
each of the at least one optical path guiding element is configured to combine the laser light of at least two colors emitted from the laser device and guide a laser beam to the first etendue adjustment component or the second etendue adjustment component; and
at least one of the first etendue adjustment component and the second etendue adjustment component is a moving component, wherein the first etendue adjustment component is configured to increase a first etendue of incident laser light and then emit the laser light that has increased the first etendue; and the second etendue adjustment component is in an output optical path of the first etendue adjustment component and is configured to increase a second etendue of incident laser light and then emit the laser light that has increased the second etendue.

15. The projection device according to claim 14, wherein any of etendue adjustment components in the projection light source is a transmissive diffuser or a reflective diffuser.

16. The projection device according to claim 14, wherein the moving component performs a rotational movement or a translational movement.

17. The projection device according to claim 14, wherein the first etendue adjustment component and the second etendue adjustment component are both moving components.

18. The projection device according to claim 14, wherein the at least one optical path guiding element comprises a first optical path guiding element and a second optical path guiding element; wherein
the first optical path guiding element is configured to combine the laser light of at least two colors emitted from the laser device and guide a laser beam to the first etendue adjustment component; and
the number of second optical path guiding elements and the number of second etendue adjustment components are both greater than or equal to one, wherein each of the second optical path guiding elements corresponds to one of the second etendue adjustment components, and is configured to receive a laser beam emitted from an etendue adjustment component other than a corresponding second etendue adjustment component and guide the received laser beam to the corresponding second etendue adjustment component.

19. The projection device according to claim 18, wherein the projection light source further comprises a phase conversion component, wherein the phase conversion component is configured to phase the received laser light; and
the first optical path guiding element comprises the phase conversion component, wherein the phase conversion component is stationary with respect to the laser device, and a portion of laser light emitted from the laser device is directed to the first etendue adjustment component through the phase conversion component; or,
each of etendue adjustment components in the projection light source is a diffusion region in a diffuser wheel, wherein the phase conversion component is fixed to the diffuser wheel, the phase conversion component covers at least a portion of a region in the diffuser wheel, and the phase conversion component rotates with a rotation of the diffuser wheel.

20. The projection device according to claim 18, wherein
the first optical path guiding element comprises a light-combining component, wherein the laser device is configured to emit laser light of a plurality of colors, and the light-combining component is configured to combine the laser light of the plurality of colors and then emit the combined laser light; and/or,
the projection light source further comprises a homogenizing-shaping component, wherein laser light is directed to the homogenizing-shaping component after passing through each of the second etendue adjustment components, or any of the second optical path guiding elements comprises two mirrors, the homogenizing-shaping component being disposed between the two mirrors; and the homogenizing-shaping component is configured to homogenize and shape the received laser light and then emit the homogenized and shaped laser light.
